(19) United States
(12) Patent Application Publication
(10) Pub. No.: US 2026/0019730 A1
(43) Pub. Date: Jan. 15, 2026

(54) SPEAKER DEVICE AND INSTALLATION STRUCTURE THEREOF

(71) Applicant: Junya MATSUOKA, Hamamatsu-shi (JP)

(72) Inventor: Junya MATSUOKA, Hamamatsu-shi (JP)

(73) Assignee: YAMAHA CORPORATION, Hamamatsu-shi (JP)

(21) Appl. No.: 19/330,269

(22) Filed: Sep. 16, 2025

Related U.S. Application Data
(63) Continuation of application No. PCT/JP2024/003474, filed on Feb. 2, 2024.

(30) Foreign Application Priority Data
Mar. 23, 2023 (JP) 2023-046689

(51) Int. Cl. H04R 1/02

(52) U.S. Cl. CPC H04R 1/025; H04R 2499/13

(57) ABSTRACT

A speaker device includes a speaker unit, and a support mechanism elastically supporting the speaker unit with respect to an external structure. The support mechanism includes a first fixing portion configured to be fixed to the external structure, a second fixing portion configured to be fixed to the external structure, and a support portion that elastically couples the speaker unit to the first fixing portion and the second fixing portion. The speaker unit is positioned between the first fixing portion and the second fixing portion as viewed in a direction of a central axis of the speaker unit, and a straight line passing through the first fixing portion and the second fixing portion is orthogonal to the central axis of the speaker unit.

### CROSS-REFERENCE TO RELATED APPLICATIONS

This is a continuation of International Application No. PCT/JP2024/003474 filed on Feb. 2, 2024, and claims priority from Japanese Patent Application No. 2023-046689 filed on Mar. 23, 2023, the entire content of which is incorporated herein by reference.

### BACKGROUND ART

The present disclosure relates to a speaker device and an installation structure thereof.

For example, various structures for installing a speaker device in a structure such as an interior of an automobile (hereinafter, referred to as an “external structure”) have been proposed in the related art. For example, Patent Literature 1 discloses a configuration in which an attachment member fixed to an external structure and a cone portion of a speaker unit are connected by a plate spring.

### CITATION LIST

### Patent Literature

Patent Literature 1: JP2022-123478A

### SUMMARY OF INVENTION

In the configuration of Patent Literature 1, since the speaker unit is supported over an entire circumference, miniaturization of the speaker device when viewed in a direction of a central axis is restricted. In consideration of the above circumstance, an object of one aspect of the present disclosure is to miniaturize a speaker device when viewed in a direction of a central axis.

In order to solve the above problems, a speaker device according to one aspect of the present disclosure includes a speaker unit, and a support mechanism configured to elastically support the speaker unit with respect to an external structure. The support mechanism includes a first fixing portion configured to be fixed to the external structure, a second fixing portion configured to be fixed to the external structure, and a support portion that elastically couples the speaker unit to the first fixing portion and the second fixing portion. The speaker unit is positioned between the first fixing portion and the second fixing portion as viewed in a direction of a central axis of the speaker unit.

An installation structure of a speaker device according to another aspect of the present disclosure includes an external structure, and a speaker device installed on the external structure. The speaker device includes a speaker unit, and a support mechanism that elastically supports the speaker unit with respect to the external structure. The support mechanism includes a first fixing portion fixed to the external structure, a second fixing portion fixed to the external structure, and a support portion that elastically couples the speaker unit to the first fixing portion and the second fixing portion. The speaker unit is positioned between the first fixing portion and the second fixing portion as viewed in a direction of a central axis of the speaker unit, and a straight line passing through the first fixing portion and the second fixing portion is orthogonal to the central axis of the speaker unit.

### BRIEF DESCRIPTION OF DRAWINGS

FIG. 1 is an installation example of an acoustic system according to a first embodiment;

FIG. 2 is an exploded perspective view of an interior member and a speaker device;

FIG. 3 is a top view of the speaker device;

FIG. 4 is a cross-sectional view taken along line IV-IV in FIG. 3;

FIG. 5 is an explanatory diagram regarding a positional relationship of each element of the speaker device;

FIG. 6 is an explanatory diagram of Comparative Example 1;

FIG. 7A is an enlarged cross-sectional view of a vicinity of an acoustic seal member, illustrating a state before the speaker device is installed on the interior member;

FIG. 7B is an enlarged cross-sectional view of the vicinity of the acoustic seal member, illustrating a state after the speaker device is installed on the interior member;

FIG. 8A is a cross-sectional view illustrating an effect according to the first embodiment and illustrating a case in which a base portion has a configuration A;

FIG. 8B is a cross-sectional view illustrating the effect according to the first embodiment and illustrating a case in which the base portion has a configuration B;

FIG. 8C is a cross-sectional view illustrating the effect according to the first embodiment and illustrating a case in which the base portion has a configuration C;

FIG. 9 is a cross-sectional view of a speaker device according to a second embodiment;

FIG. 10A is an enlarged cross-sectional view of a vicinity of an acoustic seal member according to the second embodiment, illustrating a state before the speaker device is installed on an interior member;

FIG. 10B is an enlarged cross-sectional view of the vicinity of the acoustic seal member according to the second embodiment, illustrating a state after the speaker device is installed on the interior member;

FIG. 11 is a cross-sectional view illustrating an effect of the second embodiment; and

FIG. 12 is a cross-sectional view of a speaker device according to a third embodiment.

### DESCRIPTION OF EMBODIMENTS

### A: First Embodiment

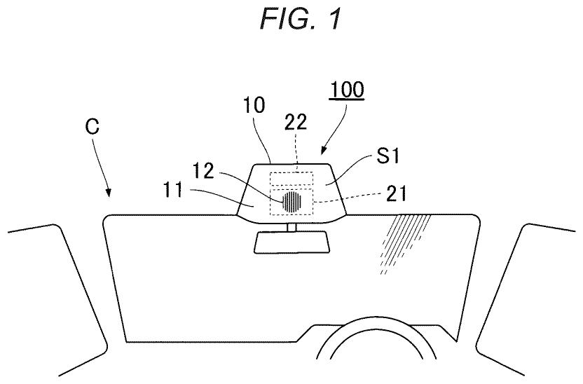

FIG. 1 is an installation example of an acoustic system 100 according to a first embodiment. The acoustic system 100 according to the first embodiment is, for example, an in-vehicle audio system installed in a vehicle C such as an automobile. Specifically, the acoustic system 100 constitutes an overhead console installed on a ceiling portion of the vehicle C.

The acoustic system 100 according to the first embodiment includes an interior member 10, a speaker device 21, and a microphone 22. The interior member 10 is a structure that constitutes an interior of the vehicle C. The interior member 10 according to the first embodiment includes a base portion 11. The base portion 11 is a plate-shaped portion including a design surface S1. The design surface S1 is a surface facing an inside of the vehicle C. The speaker device 21 and the microphone 22 are installed on a surface (hereinafter, referred to as an “installation surface S2”) of the interior member 10 opposite to the design surface S1. The interior member 10 according to the first embodiment is an example of an “external structure”.

The speaker device 21 emits sound into the vehicle C. For example, in addition to a reproduced sound of music, various sounds such as a notification voice for notifying an occupant (a driver or a passenger) of an emergency or a guidance voice for guiding the driver are emitted from the speaker device 21. The microphone 22 picks up a voice of the occupant in the vehicle C. For example, an operation voice uttered by the occupant for a voice operation of an information device in the vehicle C is picked up by the microphone 22. In the first embodiment, focus is placed on one speaker device 21 and one microphone 22 for convenience. However, two or more speaker devices 21 and two or more microphones 22 may be installed.

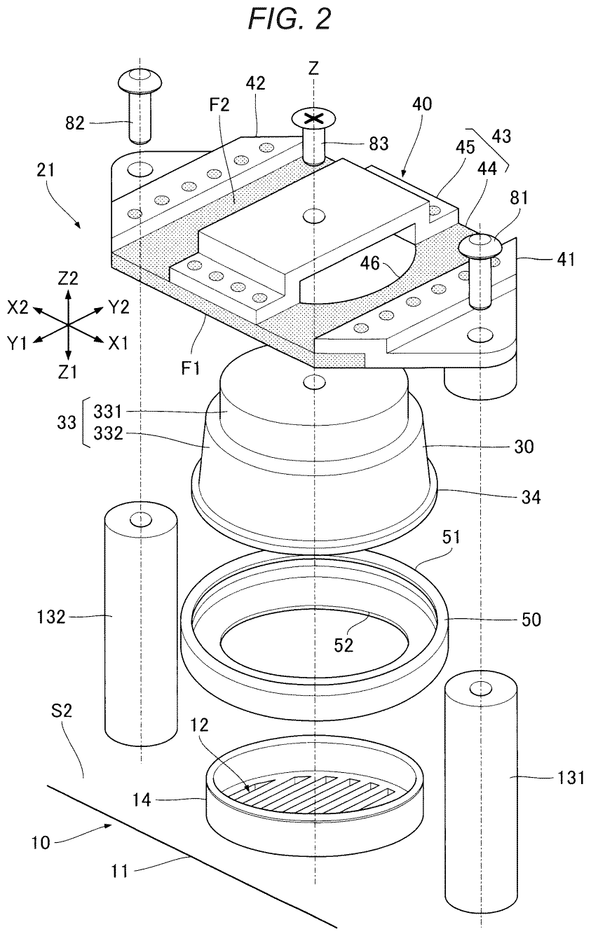

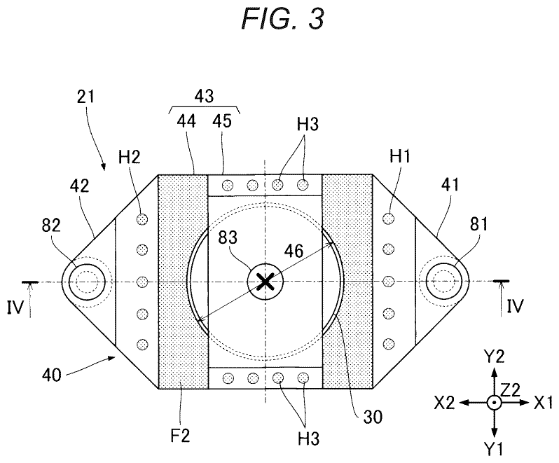

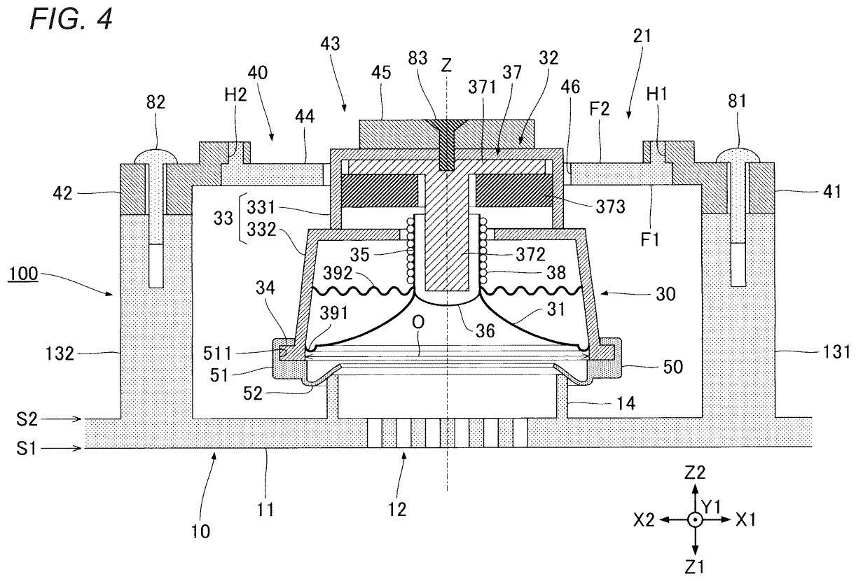

FIG. 2 is an exploded perspective view of the interior member 10 and the speaker device 21. FIG. 3 is a top view of the internal member 10 and the speaker device 21, and FIG. 4 is a cross-sectional view taken along line IV-IV in FIG. 3. In FIGS. 2 and 3, a region of an elastic plate 44 is shaded for convenience.

In the following description, a central axis Z of the speaker device 21 and an X-Y plane orthogonal to the central axis Z are assumed for convenience. One direction along an X axis is referred to as an X1 direction, and a direction opposite to the X1 direction is referred to as an X2 direction. Similarly, one direction along a Y axis is referred to as a Y1 direction, and a direction opposite to the Y1 direction is referred to as a Y2 direction.

One direction along the central axis Z is referred to as a Z1 direction, and a direction opposite to the Z1 direction is referred to as a Z2 direction. The Z1 direction is a direction toward the inside of the vehicle C. Specifically, the Z1 direction is a front side (front) of the speaker device 21, and the Z2 direction is a back side (rear) of the speaker device 21. Observation of any element of the acoustic system 100 in the direction along the central axis Z is hereinafter referred to as “plan view”.

As illustrated in FIGS. 1 and 2, a sound-emitting hole 12 is formed in a base portion 11 of the interior member 10. The sound-emitting hole 12 is an opening through which sound waves emitted from the speaker device 21 pass. The sound-emitting hole 12 is formed in a substantially circular shape by a plurality of through holes arranged in parallel to each other. The sound-emitting hole 12 may be formed by a plurality of point-shaped through holes arranged in a plane.

As illustrated in FIGS. 2 and 4, the interior member 10 includes a first support portion 131, a second support portion 132, and a protruding portion 14 in addition to the base portion 11 described above. The first support portion 131, the second support portion 132, and the protruding portion 14 protrude in the Z2 direction from the installation surface S2 of the base portion 11 opposite to the design surface S1.

The interior member 10 is formed of various resin materials or metal materials. Specifically, the interior member 10 is a molded article in which the base portion 11, the first support portion 131, the second support portion 132, and the protruding portion 14 are integrally formed by injection molding. In the first embodiment, as described above, the first support portion 131, the second support portion 132, and the protruding portion 14 protrude from the installation surface S2 in the Z2 direction. Therefore, the interior member 10 can be easily molded by separating one of a pair of molding dies used for molding the interior member 10 from the other in the Z1 direction or the Z2 direction.

The first support portion 131 and the second support portion 132 are cylindrical column-shaped portions that protrude from the installation surface S2 in the Z2 direction. The first support portion 131 and the second support portion 132 are installed at an interval from each other in the X axis direction. Specifically, the sound-emitting hole 12 is positioned between the first support portion 131 and the second support portion 132 in the plan view. The shape and dimensions of the first support portion 131 and the shape and dimensions of the second support portion 132 are the same. For example, a height of the first support portion 131 is equal to a height of the second support portion 132. The shapes of the first support portion 131 and the second support portion 132 are optional, and may be, for example, prismatic shapes.

The protruding portion 14 is a cylindrical tube-shaped portion that protrudes from the installation surface S2 in the Z2 direction. Specifically, the protruding portion 14 is formed in an annular shape surrounding the sound-emitting hole 12. The protruding portion 14 is positioned between the first support portion 131 and the second support portion 132 in the plan view. A height of the protruding portion 14 is less than the heights of the first support portion 131 and the second support portion 132.

As illustrated in FIGS. 2 and 4, the speaker device 21 includes a speaker unit 30, a support mechanism 40, and an acoustic seal member 50. Specifically, the central axis Z is a central axis of the speaker unit 30. Each element constituting the speaker device 21 according to the first embodiment will be described in detail below.

### [Speaker Unit 30]

The speaker unit 30 is a sound-emitting device that emits sound waves according to an acoustic signal supplied from an external device (not illustrated) such as an amplifying device. As illustrated in FIG. 4, the speaker unit 30 according to the first embodiment includes a diaphragm 31, a drive mechanism 32, and a support frame 33. Illustration of wiring for supplying an acoustic signal to the speaker unit 30 is omitted for convenience.

The diaphragm 31 is a vibrating body that generates sound waves by vibration. Specifically, the diaphragm 31 is a cone formed in a truncated conical tubular shape in which a diameter of an end portion in the Z1 direction exceeds a diameter of an end portion in the Z2 direction. The diaphragm 31 is manufactured by, for example, curing a resin material impregnated in a fiber-based material. A shape of the diaphragm 31 is optional, and may be, for example, a dome shape (hemispherical shape). A cylindrical tube-shaped bobbin 35 is installed on an inner circumferential edge of the diaphragm 31. An opening of an end portion of the bobbin 35 positioned in the Z1 direction is closed by a center cap 36.

The drive mechanism 32 causes the diaphragm 31 to vibrate in the direction of the central axis Z in response to an acoustic signal. Sound waves are emitted by vibration of the diaphragm 31. The central axis Z is also expressed as an axis along a direction in which the diaphragm 31 vibrates. As illustrated in FIG. 4, the drive mechanism 32 according to the first embodiment includes a magnetic circuit 37 and a voice coil 38. The magnetic circuit 37 is installed in the Z2 direction of the diaphragm 31 (that is, the back side) and generates a magnetic field. The voice coil 38 is wound around the bobbin 35 in the magnetic field generated by the magnetic circuit 37.

The magnetic circuit 37 includes a yoke 371, a center pole 372, and a magnet 373. The yoke 371 is a disk-shaped magnetic body disposed concentrically with the central axis Z. The center pole 372 is a cylindrical column-shaped magnetic body that protrudes from the yoke 371 in the Z1 direction, and is positioned inside the bobbin 35. The magnet 373 is formed in an annular shape surrounding the center pole 372.

The support frame 33 is a structure that supports the diaphragm 31 and the magnetic circuit 37. The support frame 33 is formed of, for example, a metal material or a resin material. The support frame 33 according to the first embodiment includes a first portion 331 and a second portion 332. The first portion 331 is a cylindrical tube-shaped housing that accommodates the magnetic circuit 37.

The second portion 332 supports the diaphragm 31. Specifically, the second portion 332 is a truncated conical tubular structure that surrounds the diaphragm 31. That is, a diameter of an end portion of the second portion 332 in the Z1 direction (hereinafter referred to as “sound-emitting portion 34”) exceeds a diameter of an end portion of the second portion 332 in the Z2 direction. The sound-emitting portion 34 is an annular portion that surrounds an opening O through which the sound waves emitted by the diaphragm 31 pass. As understood from the above description, the speaker unit 30 according to the first embodiment includes the sound-emitting portion 34 that surrounds the opening O through which the sound waves pass.

The outer circumferential edge of the diaphragm 31 is coupled to an inner circumferential edge of the sound-emitting portion 34 by an annular edge 391. The inner circumferential edge of the diaphragm 31 is coupled to an inner wall surface of the second portion 332 by an annular damper 392. The edge 391 and the damper 392 are formed of an elastic material.

### [Support Mechanism 40]

The support mechanism 40 in FIG. 2 is a structure that elastically supports the speaker unit 30 with respect to the interior member 10. According to the above configuration, vibration caused by a sound-emitting operation of the speaker unit 30 is prevented from being transmitted to the interior member 10. For example, the vibration of the speaker unit 30 is prevented from being transmitted to the microphone 22 via the interior member 10. The sound-emitting operation is an operation of the speaker unit 30 that emits sound waves by the vibration of the diaphragm 31.

As illustrated in FIGS. 2 to 4, the support mechanism 40 according to the first embodiment includes a first fixing portion 41, a second fixing portion 42, and a support portion 43. The first fixing portion 41 and the second fixing portion 42 are fixed to the interior member 10. The first fixing portion 41 is fixed to the first support portion 131 of the interior member 10. Specifically, the first fixing portion 41 is fixed to a top surface of the first support portion 131 by a fastener 81. The second fixing portion 42 is fixed to the second support portion 132 of the interior member 10. Specifically, the second fixing portion 42 is fixed to a top surface of the second support portion 132 by a fastener 82. The fastener 81 and the fastener 82 are, for example, screws or bolts. The first fixing portion 41 and the second fixing portion 42 are installed at an interval from each other in the X axis direction.

The support portion 43 is a structure that elastically couples the speaker unit 30 to the first fixing portion 41 and the second fixing portion 42. The speaker unit 30 is installed at a center of the support portion 43 in the plan view. An end portion of the support portion 43 in the X1 direction is fixed to the first fixing portion 41, and an end portion of the support portion 43 in the X2 direction is coupled to the second fixing portion 42. Therefore, the speaker unit 30 is positioned between the first fixing portion 41 and the second fixing portion 42 in the plan view. That is, in the plan view, the first fixing portion 41 is positioned in the X1 direction of the speaker unit 30, and the second fixing portion 42 is positioned in the X2 direction of the speaker unit 30. As understood from FIGS. 2 and 4, the speaker unit 30 is positioned between the first fixing portion 41 and the second fixing portion 42 also in a side view from a Y direction orthogonal to the central axis Z.

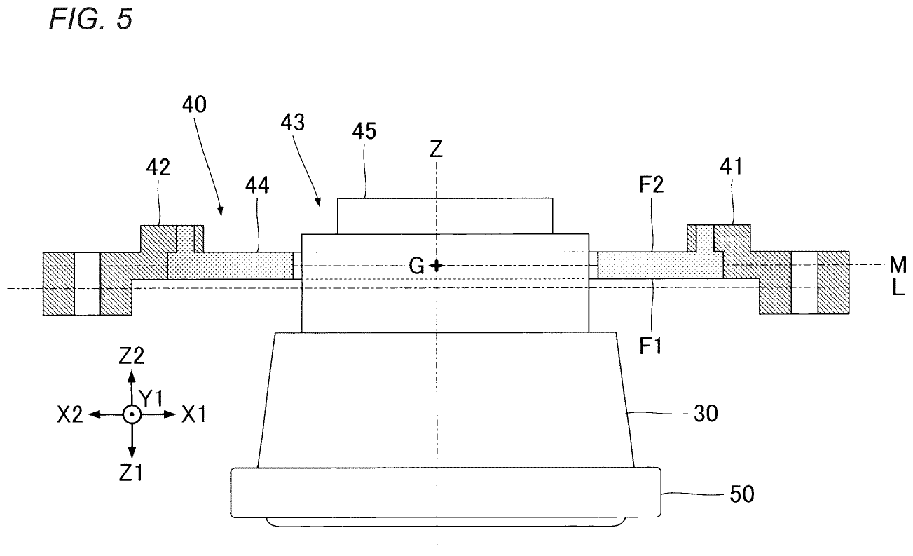

FIG. 5 is an explanatory diagram regarding a position of the speaker unit 30. As illustrated in FIG. 5, a straight line L passing through the first fixing portion 41 and the second fixing portion 42 is orthogonal to the central axis Z of the speaker unit 30. The straight line L is a straight line passing through a center of gravity of the first fixing portion 41 and a center of gravity of the second fixing portion 42. According to the above configuration, the speaker unit 30 can be supported in a well-balanced manner between the first fixing portion 41 and the second fixing portion 42.

As described above, in the first embodiment, the speaker unit 30 is elastically supported between the first fixing portion 41 and the second fixing portion 42. That is, the speaker unit 30 is supported by the interior member 10 at two positions. Therefore, for example, compared with a form in which the support mechanism 40 supports the speaker unit 30 over an entire circumference, there is an advantage that it is easier to achieve miniaturization of the speaker device 21 in a plan view.

As illustrated in FIGS. 2 to 4, the support portion 43 according to the first embodiment includes an elastic plate 44 and an attachment member 45. The elastic plate 44 is formed of an elastic material having a low elastic coefficient such as rubber or elastomer. For example, the elastic plate 44 is formed of a material having a lower elastic coefficient than the interior member 10. The first fixing portion 41 and the second fixing portion 42 are formed of a material having higher rigidity than the elastic plate 44. Similarly, the attachment member 45 is formed of a material having higher rigidity than the elastic plate 44. The first fixing portion 41, the second fixing portion 42, and the attachment member 45 are formed of, for example, the same type of resin material. The elastic plate 44 is formed of a material having a lower elastic coefficient than the resin material forming the first fixing portion 41, the second fixing portion 42, and the attachment member 45.

The elastic plate 44 is a plate-shaped member including a first surface F1 and a second surface F2. The first surface F1 and the second surface F2 are surfaces positioned on opposite sides to each other. Specifically, the first surface F1 is a surface (lower surface) facing the Z1 direction, and the second surface F2 is a surface (upper surface) facing the Z2 direction.

The elastic plate 44 is formed in an elongated shape along the X axis. An end portion of the elastic plate 44 in the X1 direction is coupled to the first fixing portion 41, and an end portion of the elastic plate 44 in the X2 direction is coupled to the second fixing portion 42. The elastic plate 44 is coupled to the first fixing portion 41 and the second fixing portion 42 such that a plate thickness direction of the elastic plate 44 is along the central axis Z of the speaker unit 30. The plate thickness direction of the elastic plate 44 is a direction normal to the first surface F1 or the second surface F2.

A circular opening 46 is formed at a center of the elastic plate 44 in the plan view. The attachment member 45 is coupled to the elastic plate 44 to overlap the opening 46 in the plan view. The attachment member 45 is formed in an elongated shape along the Y axis. An end portion in the Y1 direction and an end portion in the Y2 direction of the attachment member 45 are coupled to the elastic plate 44. That is, the attachment member 45 is suspended within the opening 46 of the elastic plate 44. As understood from the above description, a longitudinal direction of the elastic plate 44 (X axis direction) and a longitudinal direction of the attachment member 45 (Y axis direction) are orthogonal to each other.

The support mechanism 40 according to the first embodiment is, for example, a molded article formed by injection molding. Specifically, the first fixing portion 41, the second fixing portion 42, the elastic plate 44, and the attachment member 45 are integrally formed by, for example, two-color molding. That is, first, the first fixing portion 41, the second fixing portion 42, and the attachment member 45 are formed of a first resin material, and then the elastic plate 44 is formed of a second resin material different from the first resin material.

For example, the first fixing portion 41 and the elastic plate 44 are fixed by filling insides of a plurality of attachment holes H1 formed in the first fixing portion 41 with a material of the elastic plate 44. Similarly, the second fixing portion 42 and the elastic plate 44 are fixed by filling insides of a plurality of attachment holes H2 formed in the second fixing portion 42 with a material of the elastic plate 44. Further, the attachment member 45 and the elastic plate 44 are fixed by filling insides of a plurality of attachment holes H3 formed in the attachment member 45 with the material of the elastic plate 44.

The speaker unit 30 is fixed to the attachment member 45 by a fastener 83 such as a screw or a bolt. Specifically, a back surface of the speaker unit 30 is fixed to the attachment member 45 in a state in which the sound-emitting portion 34 faces the Z1 direction. That is, the speaker unit 30 is suspended from the attachment member 45.

FIG. 5 illustrates a center of gravity G of the speaker unit 30. The center of gravity G is positioned further in the Z2 direction than the first surface F1 of the elastic plate 44. Specifically, the center of gravity G is positioned between the first surface F1 and the second surface F2 of the elastic plate 44 in the direction of the central axis Z. For example, the center of gravity G is positioned on an intermediate plane M that is equidistant from the first surface F1 and the second surface F2. The center of gravity G is positioned inside the opening 46 in the plan view.

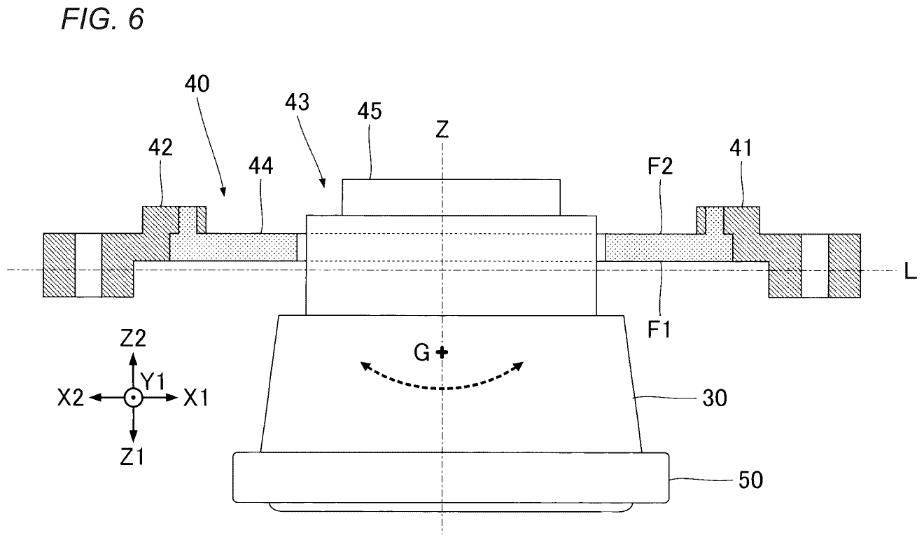

FIG. 6 is a cross-sectional view of a form in which the center of gravity G of the speaker unit 30 deviates from the first surface F1 in the Z1 direction (hereinafter, referred to as “Comparative Example 1”). As illustrated in FIG. 6, in Comparative Example 1, a significant moment around a point between the first surface F1 and the second surface F2 of the elastic plate 44 acts on the speaker unit 30 (center of gravity G). Therefore, in Comparative Example 1, the speaker unit 30 is likely to swing about the central axis Z as illustrated by the dashed arrow in FIG. 6. In contrast to Comparative Example 1, in the first embodiment, the center of gravity G of the speaker unit 30 is positioned between the first surface F1 and the second surface F2 of the elastic plate 44. Therefore, the swinging (oscillating) of the speaker unit 30 can be prevented as compared with that in Comparative Example 1.

As described above, the support mechanism 40 elastically supports the speaker unit 30. Therefore, a structure (hereinafter, referred to as a “vibration structure”) in which the speaker unit 30 vibrates in the direction of the central axis Z or a direction orthogonal to the central axis Z is formed. In the vibration structure according to the first embodiment, a resonance frequency fz of the vibration generated in the direction of the central axis Z is less than a minimum resonance frequency f0 of the speaker unit 30 (fz<f0). The minimum resonance frequency f0 is a lower limit value of a frequency that the speaker unit 30 can produce.

In a form in which the resonance frequency fz of the vibration structure exceeds the minimum resonance frequency f0 (hereinafter, referred to as “Comparative Example 2”), when the speaker unit 30 emits an acoustic component near the minimum resonance frequency f0, excessive vibration in the direction of the central axis Z may occur in the vibration structure. In contrast to Comparative Example 2, in the first embodiment, the resonance frequency fz of the vibration structure is less than the minimum resonance frequency f0 of the speaker unit 30. Therefore, even in a state in which the speaker unit 30 emits an acoustic component near the minimum resonance frequency f0, excessive vibration in the direction of the central axis Z can be reduced.

In the vibration structure according to the first embodiment, a resonance frequency fxy of vibration generated in the direction orthogonal to the central axis Z is 70 Hz or higher, and more preferably 100 Hz or higher (fxy≥100 Hz).

Vibration is likely to occur in the automobile vehicle C in which the speaker device 21 according to the first embodiment is installed. The vibration generated in the vehicle C is transmitted to the speaker device 21. On the other hand, a component of 10 Hz or higher of the vibration generated in the vehicle C is sufficiently attenuated by suspension of the vehicle C. In the first embodiment, the resonance frequency fxy of the vibration structure in the direction orthogonal to the central axis Z is set to 70 Hz or higher. Since a higher frequency of a vibration component corresponds to a higher attenuation rate, according to the first embodiment, excessive vibration of the vibration structure caused by vibration from the vehicle C can be effectively prevented. According to the configuration in which the resonance frequency fxy is set to 100 Hz or higher, the effect described above is more remarkable.

### [Acoustic Seal Member 50]

The acoustic seal member 50 in FIG. 2 seals a gap between the interior member 10 and the speaker unit 30. Since the gap is sealed by the acoustic seal member 50, the sound waves emitted from the speaker unit 30 are prevented from leaking from the gap between the sound-emitting portion 34 and the interior member 10. The acoustic seal member 50 is an annular member along the sound-emitting portion 34. The acoustic seal member 50 is installed concentrically with the sound-emitting portion 34.

As illustrated in FIGS. 2 and 4, the acoustic seal member 50 includes an attachment portion 51 and a sealing portion 52. The acoustic seal member 50 is, for example, a molded article in which the attachment portion 51 and the sealing portion 52 are integrally formed by injection molding. The acoustic seal member 50 is formed of an elastic material such as rubber or elastomer. In the following description, a direction of a circumference of a virtual circle having any diameter centered on the central axis Z is referred to as a “circumferential direction”, and a direction of a radius of the virtual circle is referred to as a “radial direction”.

The attachment portion 51 is an annular portion fixed to the sound-emitting portion 34. A groove portion 511 along the circumferential direction is formed on an inner circumferential surface of the attachment portion 51 over an entire circumference. When the sound-emitting portion 34 is accommodated in the groove portion 511, the attachment portion 51 is installed in the sound-emitting portion 34. The structure for fixing the attachment portion 51 to the sound-emitting portion 34 is optional and is not limited to the above example. The sealing portion 52 is an annular portion that protrudes inward in the radial direction from the attachment portion 51. That is, the sealing portion 52 protrudes inward from the inner circumferential surface of the attachment portion 51.

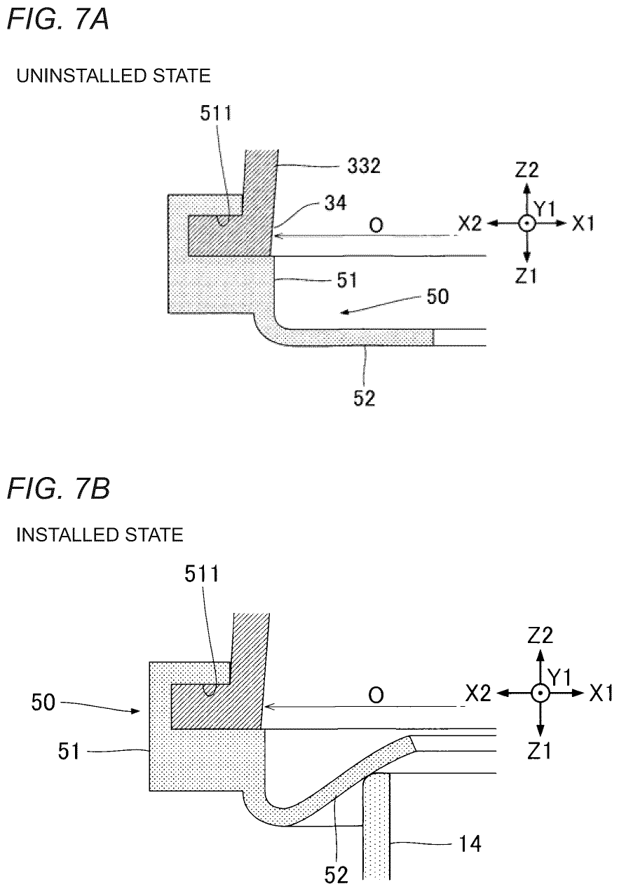

FIGS. 7A and 7B are enlarged cross-sectional views of a vicinity of the acoustic seal member 50. FIG. 7A illustrates a state before the speaker device 21 is installed on the interior member 10 (hereinafter referred to as “uninstalled state”), and FIG. 7B illustrates a state after the speaker device 21 is installed on the interior member 10 (hereinafter referred to as “installed state”). As illustrated in FIG. 7A, the sealing portion 52 in the uninstalled state is parallel to the X-Y plane.

As illustrated in FIG. 7B, in the installed state, a top surface of the protruding portion 14 comes into contact with a lower surface of the sealing portion 52 over an entire circumference of the opening O. The sealing portion 52 of the acoustic seal member 50 is elastically deformed when pressed by the protruding portion 14 in the Z2 direction. Specifically, the sealing portion 52 is curved in a curved shape in the Z2 direction from an outer circumferential edge to an inner circumferential edge. As described above, the acoustic seal member 50 comes into contact with the protruding portion 14 of the interior member 10, thereby achieving an acoustic seal that seals the gap between the sound-emitting portion 34 and the interior member 10. That is, sound emitted from the speaker unit 30 is prevented from leaking from the gap between the speaker unit 30 and the interior member 10.

As illustrated in FIG. 7B, an outer circumferential edge portion of the top surface of the protruding portion 14 has an R shape. According to the above configuration, local concentration of stress from the protruding portion 14 to the sealing portion 52 is alleviated. Therefore, damage to the sealing portion 52 due to coming into contact with the protruding portion 14 can be prevented.

As described above, in the first embodiment, the sealing portion 52 of the acoustic seal member 50 is elastically deformed when pressed by the protruding portion 14. That is, the acoustic seal member 50 is elastically deformed according to a change in a positional relationship between the protruding portion 14 and the speaker unit 30. Therefore, the vibration of the speaker unit 30 can be prevented from being transmitted to the interior member 10. Specifically, since rigidity of the acoustic seal member 50 is lower than that of the speaker unit 30, vibration transmitted from the acoustic seal member 50 to the protruding portion 14 is prevented. As described above, the rigidity of the acoustic seal member 50 is sufficiently lower than that of the speaker unit 30. A reason why the rigidity of the acoustic seal member 50 is low is that the acoustic seal member 50 is formed of a material having a low elastic coefficient and that a cantilever structure is formed by the protruding portion 14, the speaker unit 30, and the acoustic seal member 50.

Further, as a result of elastic deformation of the acoustic seal member 50 in conjunction with a change in a distance between the sound-emitting portion 34 and the protruding portion 14, a state in which the protruding portion 14 comes into contact with the acoustic seal member 50 is maintained. Therefore, the sound waves can be effectively prevented from leaking from the gap between the sound-emitting portion 34 and the interior member 10.

In the first embodiment, the sealing portion 52 protrudes inward in the radial direction from the attachment portion 51 that is fixed to the sound-emitting portion 34, and the protruding portion 14 of the interior member 10 comes into contact with the sealing portion 52. Therefore, a size of the speaker device 21 as viewed in the direction of the central axis Z can be reduced as compared with that in a configuration in which a portion that comes into contact with the protruding portion 14 protrudes outward in the radial direction from the attachment portion 51.

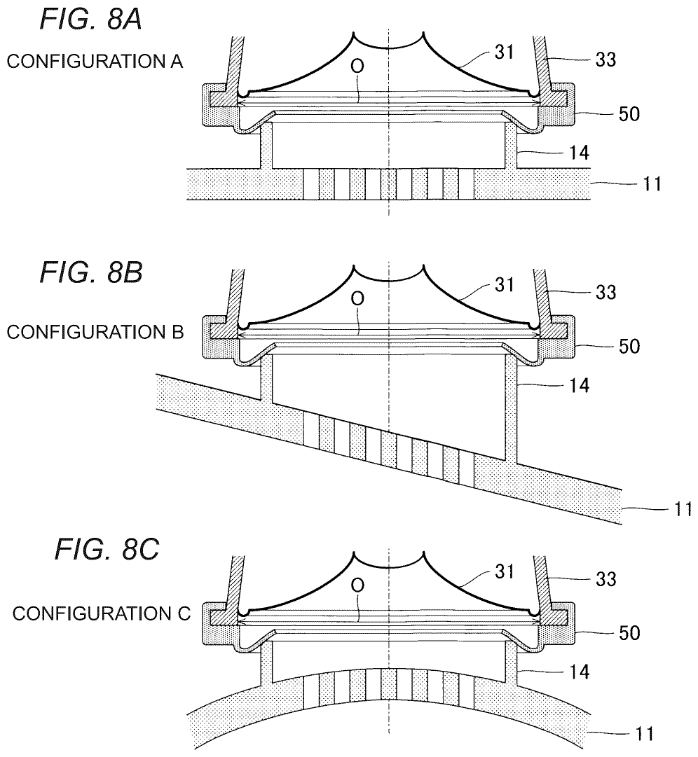

The design surface S1 of the base portion 11 of the interior member 10 is exposed to the inside of the vehicle C. Therefore, a shape of the base portion 11 is generally designed in consideration of aesthetic appearance of the design surface S1 in preference to the installation of the speaker device 21 on the base portion 11. Under the above circumstances, the shape of the base portion 11 can be variously changed for each model of the vehicle C. For example, in addition to the first embodiment (configuration A) in which the base portion 11 has a flat plate shape perpendicular to the central axis Z as illustrated in FIG. 8A, a configuration B in which the base portion 11 is inclined with respect to the central axis Z as illustrated in FIG. 8B or a configuration C in which the base portion 11 has a curved surface shape as illustrated in FIG. 8C is also assumed.

In the first embodiment, since the acoustic seal member 50 is elastically deformed by being pressed by the protruding portion 14, as illustrated in FIGS. 8A to 8C, the acoustic seal member 50 can be brought into contact with the protruding portion 14 regardless of the shape of the base portion 11. That is, even when the speaker device 21 common to the interior members 10 having different shapes is installed, the acoustic seal can be effectively maintained. As understood from the above description, according to the first embodiment, there is an advantage that a degree of freedom in design of the interior member 10 can be sufficiently ensured.

Further, since the acoustic seal member 50 is elastically deformed by being pressed from the protruding portion 14, even when the speaker device 21 common to a plurality of interior members 10 having the protruding portions 14 with different diameters is installed, the acoustic seal can be effectively maintained. That is, according to the first embodiment, the speaker device 21 can be used for the plurality of interior members 10 having different shapes of the protruding portions 14.

### B: Second Embodiment

A second embodiment will be described. In each aspect to be exemplified below, elements having the same functions as those of the first embodiment are denoted by the same reference numerals as those in the description of the first embodiment, and detailed descriptions thereof are appropriately omitted.

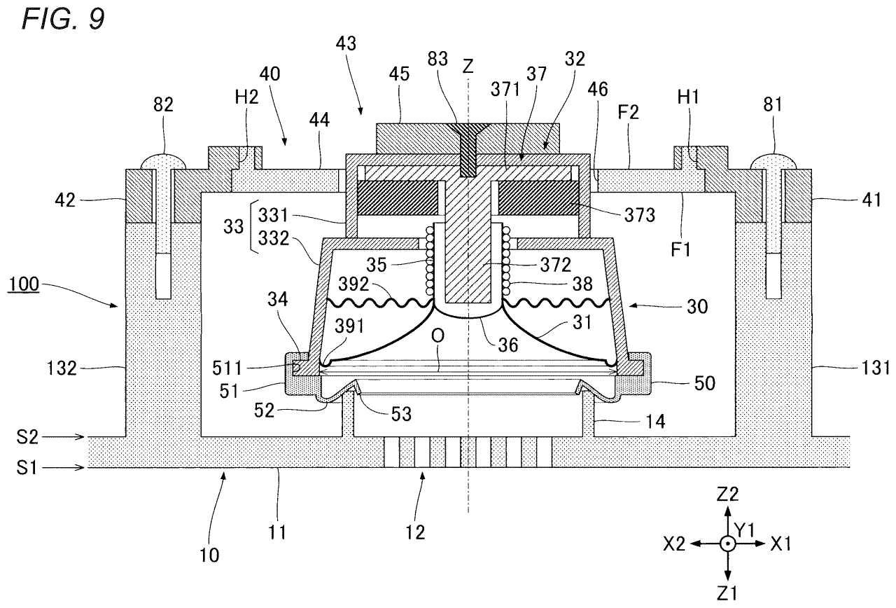

FIG. 9 is a cross-sectional view of an acoustic system 100 according to the second embodiment. In the second embodiment, a shape of the acoustic seal member 50 is different from that in the first embodiment. Specifically, the acoustic seal member 50 according to the second embodiment has a shape in which an inner circumferential portion 53 is added to the acoustic seal member 50 according to the first embodiment. The inner circumferential portion 53 is formed integrally with the attachment portion 51 and the sealing portion 52 by, for example, injection molding of a resin material.

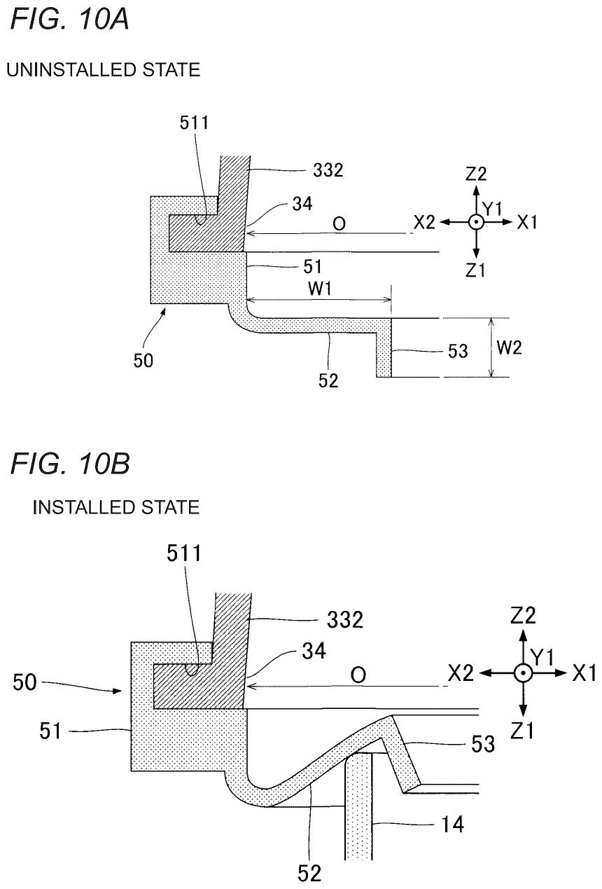

FIGS. 10A and 10B are enlarged cross-sectional views of a vicinity of the acoustic seal member 50. As illustrated in FIGS. 9, 10A, and 10B, the inner circumferential portion 53 is a portion of the acoustic seal member 50 continuous with the inner circumferential edge of the sealing portion 52. The inner circumferential portion 53 is formed in an annular shape along the inner circumferential edge of the sealing portion 52 over an entire circumference. The inner circumferential portion 53 forms an angle with respect to the sealing portion 52. Specifically, the inner circumferential portion 53 is orthogonal to the sealing portion 52.

As illustrated in FIG. 10A, in an uninstalled state, the sealing portion 52 is parallel to the X-Y plane as in the first embodiment. In an uninstalled state, the inner circumferential portion 53 protrudes from the inner circumferential edge of the sealing portion 52 in the direction along the central axis Z. Specifically, the inner circumferential portion 53 protrudes from the inner circumferential edge of the sealing portion 52 toward a side opposite to the speaker unit 30. It is also expressed as a configuration in which the inner circumferential portion 53 protrudes from the inner circumferential edge of the sealing portion 52 toward the interior member 10.

A thickness of the inner circumferential portion 53 is equal to a thickness of the sealing portion 52. However, a form in which the thickness of the inner circumferential portion 53 exceeds the thickness of the sealing portion 52 or a form in which the thickness of the inner circumferential portion 53 is less than the thickness of the sealing portion 52 is also assumed. A width W2 of the inner circumferential portion 53 is less than the width W1 of the sealing portion 52. The width W1 of the sealing portion 52 is a dimension of the sealing portion 52 in the radial direction, and the width W2 of the inner circumferential portion 53 is a dimension of the inner circumferential portion 53 in the direction of the central axis Z.

As illustrated in FIG. 10B, in an installed state, the top surface of the protruding portion 14 comes into contact with the lower surface of the sealing portion 52 over the entire circumference of the opening O as in the first embodiment. The attachment portion 51 of the acoustic seal member 50 is elastically deformed in a curved shape when pressed by the protruding portion 14 in the Z2 direction. Therefore, in the second embodiment as well, as in the first embodiment, an acoustic seal that seals the gap between the sound-emitting portion 34 and the interior member 10 is achieved.

The configuration other than the acoustic seal member 50 is the same as that according to the first embodiment. Therefore, in the second embodiment as well, effects similar to those according to the first embodiment are also achieved. Further, in the second embodiment, the inner circumferential portion 53 is provided on the inner circumferential edge of the sealing portion 52, and thus a mechanical strength of the inner circumferential edge of the sealing portion 52 is reinforced. Therefore, an increase in an inner diameter of the sealing portion 52 when pressed by the protruding portion 14 is prevented as compared with that in the first embodiment. That is, a restoring force of the sealing portion 52 against pressing by the protruding portion 14 is enhanced. With the above configuration, adhesion between the protruding portion 14 and the sealing portion 52 is improved, and as a result, according to the second embodiment, an effective acoustic seal can be achieved as compared with that in the first embodiment.

A resonance space, with an inside of the inner circumferential portion 53 acting as a neck portion, is formed between the sealing portion 52 of the acoustic seal member 50 and the diaphragm 31 of the speaker unit 30, and Helmholtz resonance may occur in this resonance space. Therefore, acoustic characteristics of the emitted sound can be adjusted according to characteristics (for example, elastic characteristics) and dimensions of the inner circumferential portion 53.

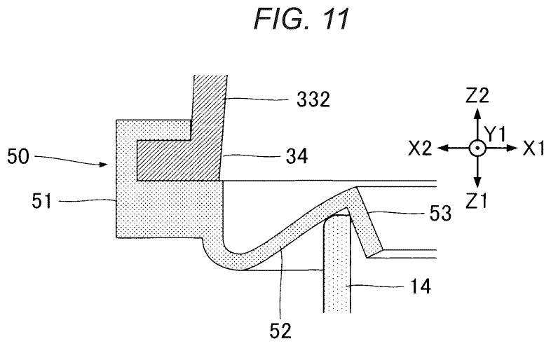

In the first embodiment, the inner circumferential portion 53 protrudes from the inner circumferential edge of the sealing portion 52 toward the side opposite to the speaker unit 30. According to the above configuration, in a process in which the protruding portion 14 approaches an inner circumferential side of the sealing portion 52 while pressing the sealing portion 52, a movement of the protruding portion 14 with respect to the sealing portion 52 is stopped by the protruding portion 14 coming into contact with the inner circumferential portion 53 as illustrated in FIG. 11. Therefore, the protruding portion 14 is prevented from reaching an inside of the sealing portion 52. That is, the inner circumferential portion 53 functions as a stopper that prevents the protruding portion 14 from reaching the inside of the sealing portion 52. Further, since a duct shape is formed by the inner circumferential portion 53 at an air inlet or outlet (opening O) with respect to a space inside the sound-emitting portion 34, the airflow is regulated, and as a result, wind noise can be reduced.

### C: Third Embodiment

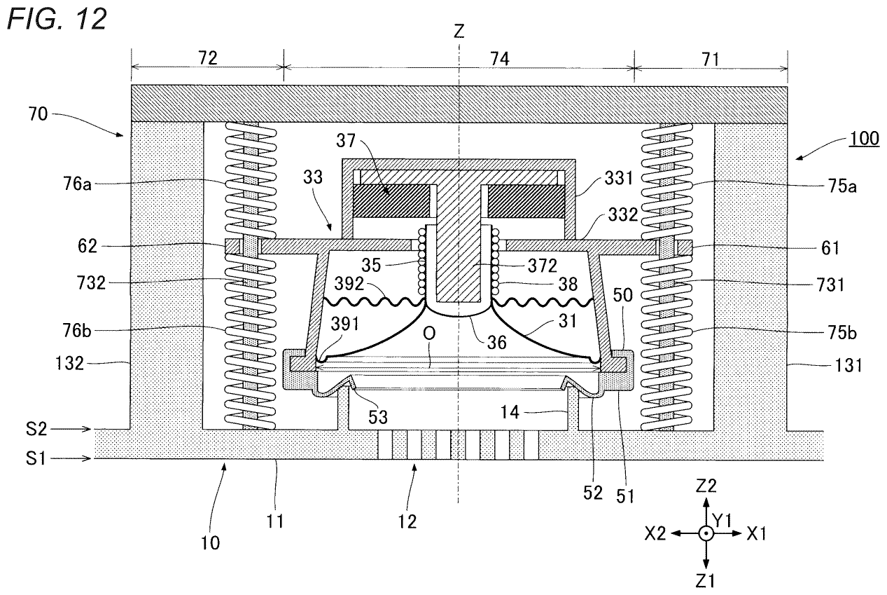

FIG. 12 is a cross-sectional view of an acoustic system 100 according to a third embodiment. The speaker unit 30 according to the third embodiment includes a first arm portion 61 and a second arm portion 62 in addition to the same elements as those in the first embodiment. The first arm portion 61 and the second arm portion 62 are coupled to the support frame 33 (specifically, the first portion 331). The first arm portion 61 protrudes from the support frame 33 in the X1 direction, and the second arm portion 62 protrudes from the support frame 33 in the X2 direction. That is, the support frame 33 is positioned between the first arm portion 61 and the second arm portion 62.

In the third embodiment, the support mechanism 40 according to the first embodiment is replaced with a support mechanism 70 in FIG. 12. The support mechanism 70 is a structure that elastically supports the speaker unit 30 with respect to the interior member 10. Therefore, similarly to the first embodiment, vibration caused by a sound-emitting operation of the speaker unit 30 is prevented from being transmitted to the interior member 10.

The support mechanism 70 according to the third embodiment includes a first fixing portion 71, a second fixing portion 72, a support portion 73, and a coupling portion 74. The first fixing portion 71 and the second fixing portion 72 are fixed to the interior member 10. Specifically, the first fixing portion 71 is fixed to the top surface of the first support portion 131. The second fixing portion 72 is fixed to the top surface of the second support portion 132. The coupling portion 74 couples the first fixing portion 71 and the second fixing portion 72. The first fixing portion 71 is positioned in the X1 direction of the coupling portion 74, and the second fixing portion 72 is positioned in the X2 direction of the coupling portion 74. The coupling portion 74 may be omitted. A form in which the first fixing portion 71 includes the first support portion 131 or a form in which the second fixing portion 72 includes the second support portion 132 is also assumed.

The support portion 73 is a structure that elastically couples the speaker unit 30 to the first fixing portion 71 and the second fixing portion 72. Specifically, the support portion 73 includes a first guide portion 731, a second guide portion 732, a first upper spring 75a, a first lower spring 75b, a second upper spring 76a, and a second lower spring 76b.

The first guide portion 731 is a columnar portion extending between a lower surface of the first fixing portion 71 and the installation surface S2 of the base portion 11. Similarly, the second guide portion 732 is a columnar portion extending between a lower surface of the second fixing portion 72 and the installation surface S2 of the base portion 11. The first guide portion 731 is inserted into a through hole formed in the first arm portion 61 of the speaker unit 30. The second guide portion 732 is inserted into a through hole formed in the second arm portion 62 of the speaker unit 30. Therefore, the speaker unit 30 is positioned between the first guide portion 731 and the second guide portion 732 in the plan view. The first guide portion 731 and the second guide portion 732 are guides that regulate a movement of the speaker unit 30 in a direction in the X-Y plane.

The first upper spring 75a is positioned between the first fixing portion 71 and the first arm portion 61, and the first lower spring 75b is positioned between the first arm portion 61 and the base portion 11. Similarly, the second upper spring 76a is positioned between the second fixing portion 72 and the second arm portion 62, and the second lower spring 76b is positioned between the second arm portion 62 and the base portion 11. Therefore, when the speaker unit 30 moves in the Z2 direction, an elastic force in the Z1 direction acts from the support portion 73, and when the speaker unit 30 moves in the Z1 direction, an elastic force in the Z2 direction acts from the support portion 73. That is, the support mechanism 70 according to the third embodiment prevents the movement of the speaker unit 30 in the direction of the central axis Z.

As understood from FIG. 12, the speaker unit 30 is positioned between the first fixing portion 71 and the second fixing portion 72 in the plan view. That is, in the plan view, the first fixing portion 71 is positioned in the X1 direction of the speaker unit 30, and the second fixing portion 72 is positioned in the X2 direction of the speaker unit 30.

As described above, in the third embodiment, similarly to the first embodiment, the speaker unit 30 is supported by the interior member 10 at two positions. Therefore, for example, compared with a form in which the support mechanism 70 supports the speaker unit 30 over the entire circumference, it is easier to achieve miniaturization of the speaker device 21 in the plan view.

### D: Modifications

Specific modified aspects added to the above-exemplified aspects will be exemplified below. Two or more aspects freely selected from the following examples may be combined as appropriate within a mutually consistent range.
(1) In each of the above embodiments, the form in which the sound-emitting portion 34 is annular (particularly annular) in shape is exemplified. However, a planar shape of the sound-emitting portion 34 is not limited to the above examples. For example, a form in which the sound-emitting portion 34 has an elliptical or oval annular shape is also assumed. A form in which the sound-emitting portion 34 has a polygonal frame shape is also assumed. As understood from the above examples, the sound-emitting portion 34 may have a planar shape that surrounds the opening O through which the sound waves emitted from the speaker unit 30 pass.
(2) In each of the above embodiments, the form in which the sealing portion 52 of the acoustic seal member 50 protrudes inward in the radial direction from the attachment portion 51 is exemplified. However, the sealing portion 52 may protrude outward in the radial direction from the attachment portion 51. The protruding portion 14 is formed to have a larger diameter than the attachment portion 51 to come into contact with the sealing portion 52.
(3) In each of the above embodiments, the configuration in which the center of gravity G is positioned between the first surface F1 and the second surface F2 of the elastic plate 44 is exemplified. However, the position of the center of gravity G is not limited to the above examples. Specifically, a configuration in which the center of gravity G is positioned further in the Z1 direction than the first surface F1 is also assumed. For example, a configuration in which the center of gravity G is positioned in a vicinity of the first surface F1 (or the second surface F2) to such an extent that swing of the speaker unit 30 is substantially prevented is exemplified. More specifically, a configuration in which the center of gravity G is positioned in the vicinity of the first surface F1 (or the second surface F2) to such an extent that a resonance frequency related to the swing of the speaker unit 30 is 100 Hz or higher is preferable.
(4) In each of the above embodiments, the structure in which the speaker device 21 is installed on the interior member 10 of the vehicle C is exemplified. However, the structure (external structure) in which the speaker device 21 is installed is not limited to the interior member 10.
(5) In each of the above embodiments, the configuration in which the support mechanism 40 is fixed to the first support portion 131 and the second support portion 132 is exemplified. In the above configurations, the speaker unit 30 is supported by the interior member 10 at two points. However, the structure for supporting the speaker unit 30 is not limited to the above examples. For example, the speaker unit 30 may be supported by the interior member 10 at three or more points.
(6) In each of the above embodiments, the following configuration A and configuration B are exemplified. Configuration A: The configuration in which the acoustic seal member 50 along the sound-emitting portion 34 of the speaker unit 30 is elastically deformed when pressed by the protruding portion 14. Configuration B: The configuration in which the speaker unit 30 is positioned between the first fixing portion 41 (71) and the second fixing portion 42 (72) in the plan view.

Each of the configuration A and the configuration B can be independently established. Therefore, one of the configuration A and the configuration B is not an essential requirement for the other.

For example, in the acoustic system 100 adopting the configuration A, the configuration B is not essential. Specifically, for the configuration A, the configuration for supporting the speaker unit 30 is optional. In the acoustic system 100 adopting the configuration B, the configuration A is not essential. Specifically, for the configuration B, presence or absence and the configuration of the acoustic seal member 50 are optional.

### E: Appendix

For example, the following configurations can be understood from the above-exemplified embodiments.

A speaker device according to one aspect (aspect 1) of the present disclosure, including: a speaker unit; and a support mechanism configured to elastically support the speaker unit with respect to an external structure, in which the support mechanism includes a first fixing portion configured to be fixed to the external structure, a second fixing portion configured to be fixed to the external structure, and a support portion that elastically couples the speaker unit to the first fixing portion and the second fixing portion, and the speaker unit is positioned between the first fixing portion and the second fixing portion as viewed in a direction of a central axis of the speaker unit. In the above aspect, the speaker unit is elastically supported between the first fixing portion and the second fixing portion. Therefore, for example, as compared with a form in which the support mechanism supports the speaker unit over an entire circumference, it is easier to achieve miniaturization of the speaker device when viewed in the direction of the central axis.

In a specific example (aspect 2) of the aspect 1, a straight line passing through the first fixing portion and the second fixing portion is orthogonal to the central axis of the speaker unit. According to the above aspect, the speaker unit can be supported in a well-balanced manner between the first fixing portion and the second fixing portion.

In a specific example (aspect 3) of the aspect 1 or 2, the support portion includes an elastic plate whose plate thickness direction extends along the central axis of the speaker unit, the elastic plate has a first surface and a second surface opposite to each other, and a center of gravity of the speaker unit is positioned between the first surface and the second surface in the direction of the central axis. In the above aspect, the center of gravity of the speaker unit is positioned between the first surface and the second surface in the direction of the central axis. Therefore, swinging (oscillating) of the speaker unit can be prevented as compared with a form in which the center of gravity of the speaker unit deviates from a range between the first surface and the second surface.

In a specific example (aspect 4) of any one of the aspects 1 to 3, in a vibration structure including the speaker unit and the support mechanism, a resonance frequency of vibration in the direction of the central axis is less than a minimum resonance frequency of the speaker unit. In the above aspect, the resonance frequency of the vibration in the direction of the central axis in the vibration structure is less than the minimum resonance frequency (f0) of the speaker unit. Therefore, excessive vibration of the vibration structure in the direction of the central axis can be effectively prevented.

In a specific example (aspect 5) of any one of the aspects 1 to 4, in the vibration structure including the speaker unit and the support mechanism, a resonance frequency of vibration in a direction orthogonal to the central axis is 100 Hz or higher. For example, assuming that a speaker device is installed in a moving body such as an automobile, vibration (a component of 10 Hz or higher) from the moving body is sufficiently attenuated by a suspension of the moving body. Therefore, according to the aspect in which the resonance frequency of the vibration of the vibration structure in the direction orthogonal to the central axis is 100 Hz or higher, the excessive vibration of the vibration structure due to the vibration from the moving body can be effectively prevented.

In a specific example (aspect 6) of any one of aspects 1 to 5, the speaker device further including: an acoustic seal member, in which the speaker unit includes a sound-emitting portion that surrounds an opening through which sound waves pass, and the acoustic seal member is installed along the sound-emitting portion and elastically deformed upon being pressed by a protruding portion that protrudes from an installation surface of the external structure and surrounds a sound-emitting hole of the external structure. In the above aspect, the acoustic seal member along the sound-emitting portion comes into contact with the protruding portion of the external structure, thereby achieving an acoustic seal that seals a gap between the sound-emitting portion and the external structure. That is, sound emitted from the speaker unit is prevented from leaking from the gap between the speaker unit and the external structure.

An installation structure according to one aspect (aspect 7) of the present disclosure, including: an external structure; and a speaker device installed on the external structure, in which the speaker device includes a speaker unit, and a support mechanism that elastically supports the speaker unit with respect to the external structure, and the support mechanism includes a first fixing portion fixed to the external structure, a second fixing portion fixed to the external structure, and a support portion that elastically couples the speaker unit to the first fixing portion and the second fixing portion, and the speaker unit is positioned between the first fixing portion and the second fixing portion when viewed in a direction of a central axis.

What is claimed is:

1. A speaker device comprising:
a speaker unit; and
a support mechanism configured to elastically support the speaker unit with respect to an external structure, wherein the support mechanism includes:
a first fixing portion configured to be fixed to the external structure;
a second fixing portion configured to be fixed to the external structure; and
a support portion that elastically couples the speaker unit to the first fixing portion and the second fixing portion,
wherein the speaker unit is positioned between the first fixing portion and the second fixing portion as viewed in a direction of a central axis of the speaker unit, and
wherein a straight line passing through the first fixing portion and the second fixing portion is orthogonal to the central axis of the speaker unit.

2. The speaker device according to claim 1, wherein:
the support portion includes an elastic plate whose plate thickness direction is parallel to the central axis of the speaker unit,
the elastic plate has a first surface and a second surface opposite to each other, and
a center of gravity of the speaker unit is positioned between the first surface and the second surface in the direction of the central axis of the speaker unit.

3. The speaker device according to claim 1, wherein, in a vibration structure including the speaker unit and the support mechanism, a resonance frequency of vibration in the direction of the central axis is less than a minimum resonance frequency of the speaker unit.

4. The speaker device according to claim 1, wherein, in a vibration structure including the speaker unit and the support mechanism, a resonance frequency of vibration in a direction orthogonal to the central axis of the speaker unit is 70 Hz or higher.

5. The speaker device according to claim 1, further comprising:
an acoustic seal member,
wherein the speaker unit includes a sound-emitting portion that surrounds an opening through which sound waves pass, and
wherein the acoustic seal member is installed along the sound-emitting portion and is configured to be elastically deformed upon being pressed by a protruding portion that protrudes from an installation surface of the external structure and surrounds a sound-emitting hole of the external structure.

6. The speaker device according to claim 1, wherein the external structure is an interior member of an automobile.

7. An installation structure of a speaker device, the installation structure comprising:
an external structure; and
a speaker device installed on the external structure, wherein the speaker device includes:
a speaker unit; and
a support mechanism that elastically supports the speaker unit with respect to the external structure, wherein the support mechanism includes:
a first fixing portion fixed to the external structure;
a second fixing portion fixed to the external structure; and
a support portion that elastically couples the speaker unit to the first fixing portion and the second fixing portion,
wherein the speaker unit is positioned between the first fixing portion and the second fixing portion as viewed in a direction of a central axis of the speaker unit, and wherein a straight line passing through the first fixing portion and the second fixing portion is orthogonal to the central axis of the speaker unit.

8. The installation structure according to claim 7, wherein the external structure is an interior member of an automobile.
